(19) United States
(12) Patent Application Publication
(10) Pub. No.: US 2014/0320665 A1
(43) Pub. Date: Oct. 30, 2014

(54) SYSTEM FOR READING A METER

(71) Applicant: BACSOFT LTD., KIRYAT GAT (IL)

(72) Inventors: ILAN FELDMAN, KIBBUTZ HULDA (IL); NOAM NAHLIELI, MOSHAV YINON (IL); AMIR BEN SHALOM, MODIIN (IL)

(21) Appl. No.: 14/261,443

(22) Filed: Apr. 25, 2014

Related U.S. Application Data
(60) Provisional application No. 61/815,741, filed on Apr. 25, 2013.

(51) Int. Cl. G01D 9/42

(52) U.S. Cl. CPC G01D 9/42
USPC 348/160

(57) ABSTRACT

A system for reading a meter is provided. The meter comprises a visual display behind by a transparent cover, the visual display comprising one or more indicators each representing a sub-value and together representing a metered value measured by the meter. The system comprises an imaging unit comprising an imaging device and an adhesive configured to facilitate mounting of the imaging unit over the cover of the meter such that the imaging device faces the visual display, and a processor configured to recognize values represented by the indicators are imaged and calculate, based thereon, the metered value.

### CROSS-REFERENCE TO RELATED APPLICATIONS

This application claims the benefit of priority of U.S. Provisional Patent Application No. 61/815,741, filed Apr. 25, 2013, the disclosure of which is incorporated herein by reference in its entirety.

### FIELD OF THE INVENTION

The presently disclosed subject matter relates to readers for water meters of network piping systems. In particular, it relates to readers which are suitable for being retrofitted on such meters.

### BACKGROUND OF THE INVENTION

A mechanical meter is an device used in industrial environments such as for water, gas or electric systems. Water supply providers or water corporations, for example, use mechanical meters for residential and commercial purposes of water resource management. In such systems, the mechanical meter measures the volume of water usage, enabling water network monitoring and facilitating billing.

A typical mechanical meter has an analog display, commonly fitted into an externally bounded box with a metal or a plastic lid, at a size suitable for covering its display unit. Generally, the mechanical meter is known for its reliability and accuracy, and reading of the display measurements is handled visually at the location of the installed device.

### SUMMARY OF THE INVENTION

Aspects of the present disclosure relates to remote display reading functionality of a mechanical meter, suited in a “retrofit” or “add-on” manner for different mechanical metering mechanisms such as water meters, electric power meters or gas meters. In particular, the disclosure relates to mechanical water meters of three inches in diameter and above, not having a wireless solution.

In general, the technology of automatically collecting consumption, diagnostic, and status data by using a mechanical meter or energy metering devices (gas, electric) and transferring that data to a centrally managed database for billing, troubleshooting, and analyzing. This technology mainly saves utility providers the expense of periodic trips to each physical location to read a meter. Another advantage is that billing can be based on near real-time consumption rather than on estimates based on past or predicted consumption. This timely information coupled with analysis can help both utility providers and customers to better control the use and production of electric energy, gas usage, or water consumption.

It is noted that the current disclosure enables keeping the existing piping network with minimal changes, while adding the functionally of remote monitoring.

Embodiments described herein disclose a new method and system to add cost effective remote reading solution to existing mechanical meters in existing piping network with minimal changes.

Such solution incorporates a transparent sticker that may be adhered to the display of a mechanical meter, comprising a simple built-in image acquisition device, such as a simple camera or electro-optical sensors, to acquire a mechanical meter reading display image, and is configured to communicate with an analyzing mechanism, using a power source and fitted into an internal add-on housing hinged to the mechanical meter, in a replaceable meter lid, for example.

The internal analyzing mechanism may include an internal processing unit, a transmission module configured to communicate with the image acquisition devices through a flexible cable, and the power source unit.

Optionally, the power source may be of a rechargeable type using a solar battery charger installed inside the top of its housing.

Optionally, the power source may be a battery cell of a rechargeable type, D3 size, ensuring operation for at least seven years.

Optionally, the internal processing unit may comprise a motion detection sensor for detecting and alerting theft or vandalism.

Optionally, the internal processing unit may further comprise a magnetic sensor for detecting magnetic field fraud.

It is noted, that in any given period of time, thereafter, the frequency of reading, and a new image may be acquired and analyzed by the software allowing obtaining the identification number specified by the mechanical meter. The identification number may then be stored in the device memory and transmitted to a remote server every pre-configured time, thereafter, the transmission frequency. The measurement data may be stored on a central server having a database accessible for additional applications system.

It is noted that the systems and methods of the disclosure herein may not be limited in its application to the details of construction and the arrangement of the components or methods set forth in the description or illustrated in the drawings and examples. The systems and methods of the disclosure may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

According to one aspect of the presently disclosed subject matter, there is provided a system for reading a meter, the meter comprising a visual display behind by a transparent cover, the visual display comprising one or more indicators each representing a sub-value and together representing a metered value measured by the meter, the system comprising:
an imaging unit comprising an imaging device and an adhesive configured to facilitate mounting of the imaging unit over the cover of the meter such that the imaging device faces the visual display; and
a processor configured to recognize values represented by the indicators are imaged and calculate, based thereon, the metered value.

The imaging unit may comprise an adhesive sheet comprising the imaging device. The sheet may comprise conductive lines configured to electrically connect the imaging device to the processor printed thereon.

The imaging unit may further comprise a light source. The light source may comprise a light emitting diode.

The system may further comprise a communications element configured for wirelessly communicating the calculated values with a remote system. The communications element may be configured for communicating over a cellular network (sometimes referred to as a “mobile network”).

It will be appreciated that herein the specification and claims, the terms “cellular network” and “mobile network” may be used interchangeably, and refer to a wireless network distributed over land areas called cells, each served by at least one fixed-location transceiver, known as a cell site or base station. In such a network, each cell uses a different set of frequencies from neighboring cells, to avoid interference and provide guaranteed bandwidth within each cell. In addition, these terms are to be understood generically as referring to any network deployed by one or more telecommunications providers to connect mobile phones, mobile computing devices, and other similar devices to the public switched telephone network, public Internet, etc., or to a similar private network.

The system may further comprise a cap configured to be retrofitted to the meter. The cap may house functional elements of the system therewithin, such as the processor.

The cap may be configured to be hingedly articulated to the meter. It may comprise a spring configured to bias it to a closed position on the meter.

The system may further comprise a power source. The power source may comprise one or more batteries. The batteries may be rechargeable, in which case the power source may further optionally comprise a solar cell configured to provide power to recharge them.

The meter may be a water meter. Each of at least a portion of the indicators may represent a different decimal position of a metered volume of water. The portion of indicators may comprise dials (i.e., needles) and/or mechanical counters. The portion may comprise a digital display.

According to another aspect of the presently disclosed subject matter, there is provided a method for reading an analog meter, the method comprising:
providing a meter comprising a visual display behind by a transparent cover, the visual display comprising one or more indicators each representing a sub-value and together representing a metered value measured by the meter;
providing a system configured to be fitted to the meter so as to image the visual display, the system comprising an imaging unit having an imaging device and an adhesive configured to facilitate mounting of the imaging unit on the cover of the meter such that the imaging device faces the visual display, and a processor configured to recognize values represented by the indicators;
imaging, by the imaging device, of the visual display;
recognizing, by the processor, values represented by the indicators as imaged; and
calculating, by the processor, based on the recognized values, the metered value.

The imaging unit may comprise an adhesive sheet comprising the imaging device. The sheet may comprise conductive lines configured to electrically connect the imaging device to the processor printed thereon.

The imaging unit may further comprise a light source. The light source may comprise a light emitting diode.

The system may further comprise a communications element configured for wirelessly communicating the calculated values with a remote system, the method further comprising transmitting the calculated values to the remote system. The transmitting may be performed over a cellular network.

The system may further comprise a cap configured to be retrofitted to the meter. The cap may house functional elements of the system therewithin, such as the processor.

The cap may be configured to be hingedly articulated to the meter. It may comprise a spring configured to bias it to a closed position on the meter.

The system may further comprise a power source. The power source may comprise one or more batteries. The batteries may be rechargeable, in which case the power source may further optionally comprise a solar cell configured to provide power to recharge them.

The meter may be a water meter. Each of at least a portion of the indicators may represent a different decimal position of a metered volume of water. The portion of indicators may comprise dials and/or mechanical counters. The portion may comprise a digital display.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a block diagram showing selected elements of a possible industrial water network monitoring system;

FIG. 2A illustrates a water meter for use with the presently disclosed subject matter;

FIGS. 2B through 2D illustrate examples of visual displays of the water meter illustrated in FIG. 2A;

FIG. 3 illustrates an example of a system configured to be retrofitted to the meter illustrated in FIG. 2A;

FIG. 4 is a flow chart representing a method for managing remote monitoring of a mechanical meter;

FIG. 5A is a flow chart representing a method for image acquisition of a mechanical meter display;

FIG. 5B is a flow chart representing a method for image acquisition of a mechanical meter display; and

FIG. 5C provides a possible method of receiving readings data of a mechanical meter display

### DETAILED DESCRIPTION

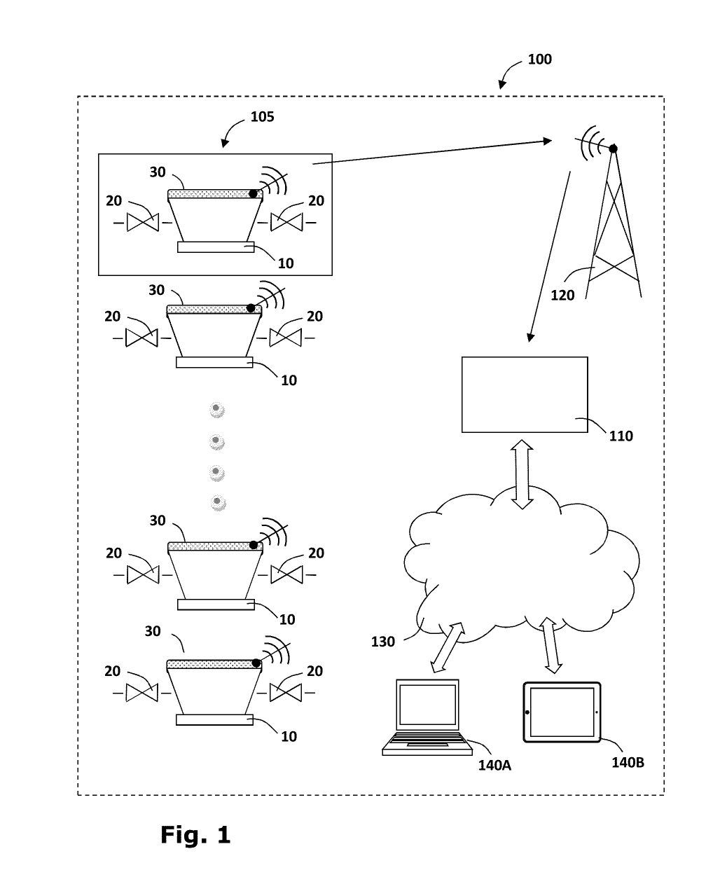

FIG. 1 illustrates a network 100 for monitoring a plurality of mechanical meters, as water meters, configured to communicate with a remote computing device to transmit thereto metered flow values, e.g., for storage in a centrally managed database, accessible through a computerized external application.

The network 100 comprises a plurality of mechanical meters 105, each of which is configured to communicate with a remote management server 110, for example via a cellular network antenna 120. The remote management server 110 may be provided to store flow reading data for each mechanical meter in a centrally managed database, accessible to a communication cloud 130 via one or more electronic devices, for example, as illustrated, computers 140a, tablet computers 140b, or any other suitable devices, such as a mobile phone built on a mobile operating system (also referred to as a “smartphone”), a personal digital assistant, etc. or the like executing a program such as a device specific application installed thereupon.

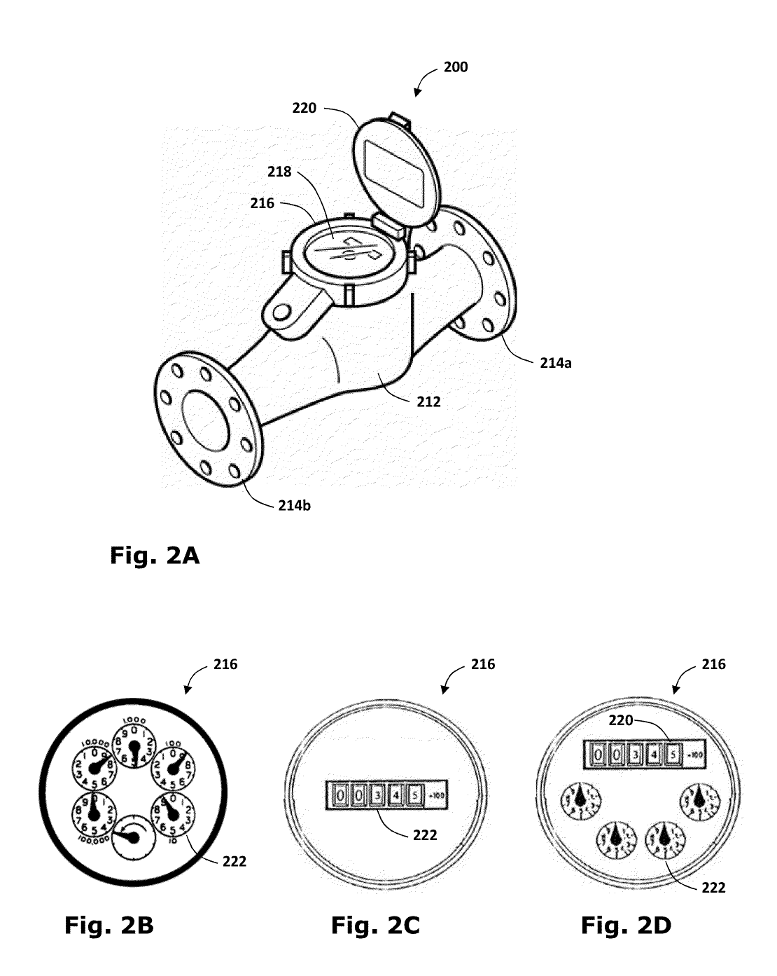

Reference is now made to FIG. 2A, showing a possible mechanical meter illustration, configured for connecting the mechanical meter to a piping network.

The mechanical meter 200 includes a body 212 of a mechanical structure having upstream and downstream flanges 214a and 214b to enable connecting the mechanical meter to a piping network, for example using connecting valves (not illustrated), a visual display 216 behind a transparent cover 218 mounted on the body, and a rigid cap 220 hingedly articulated to the body configured, when in a closed position (not illustrated) to cover the visual display. Typically, the cap 220 is articulated to the body 212 via a shaft (not illustrated) or other arrangement which facilitates removal thereof from the body and replacement with another similar cap.

It will be appreciated that the body 212 houses one or more suitable internal mechanisms configured to perform measurements of water flowing therethrough. These internal mechanisms are connected to the visual display 216 so as to display the metered (i.e., measured) values.

As illustrated in FIGS. 2B through 2D, the visual display 216 comprises one or more indicators 222, each representing a sub-value of the metered value. The visual display may be configured such that each of the indicators represents a different decimal position of the metered value, as is known in the art. The indicators 222 may comprise, e.g., dials, as illustrated in FIG. 2B, mechanical counters, as illustrated in FIG. 2C, or a combination of both, as illustrated in FIG. 2D. In addition and/or alternatively, the indicators may constitute part of an electronic display (not illustrated), for example via a liquid crystal display (LCD).

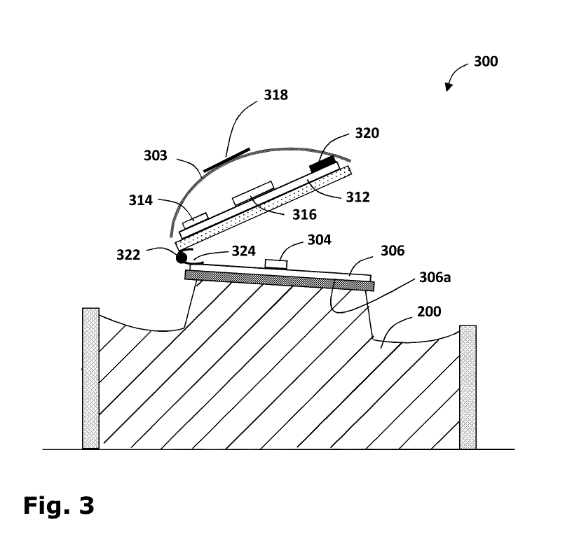

As illustrated in FIG. 3, a system 300 is provided, configured to be retrofitted to the meter 200 described above with reference to FIGS. 2A through 2D. The system 300 facilitates remote monitoring of the metered volume. The system 300 comprises an imaging unit, which is generally indicated at 301, and a cap, which is generally indicated at 303 and shown in cross-section in order to illustrate internal components thereof, and which houses functional elements of the system.

The imaging unit is configured to be mounted over the transparent cover 218 of the meter 200 and to digitally image the visual display 216 thereof. Accordingly, it comprises an adhesive sheet 306 comprising an imaging device 304. The imaging device 304 may be any device suitable for capturing an imaging an converting it to a digital stream suitable for storage on a digital medium, and comprises an objective and a suitable digital sensor, such as a Charged Coupled Device (CCD) or a Complementary Metal Oxide Semiconductor (CMOS) sensor.

According to some examples, the adhesive sheet 306 is translucent to a degree wherein the values presented by the visual display are still distinguishable by the imaging device 304. According to further examples, it is transparent. According to still further examples, the adhesive sheet 306 is provided with an aperture (not illustrated) below the imaging device 304, such that it may image the visual display 216 without interference by the sheet. It may provide a level of protection for the cover 218 of the meter, for example against wear and tear, etc.

The adhesive sheet 306 comprises an adhesive surface 306a configured for facilitating the mounting of the sheet on the cover 218 of the meter 200. The entire surface 306a may be provided with an adhesive coating, for example except for the area below the imaging device 304. Alternatively, only portions of the surface 306a, for example strips of one or more circulars rings, may be provided with an adhesive coating.

The imaging device 304 may be attached to either side of the sheet 306, with its objective facing the adhesive surface 306a. Alternatively, it may be embedded within the adhesive sheet 306 with its objective facing the adhesive surface 306a.

As mentioned above, the cap 303 houses functional elements of the system 300. Accordingly, it comprises an electronic circuit card 312 which includes a processor, a communications element 314, and a power source 316. In addition, a flexible cable 324 is provided to connect between functional elements in the cap 303 and the imaging device 304. In order to facilitate the connection, the adhesive sheet 306 may comprise conductive lines (not illustrated) printed thereon and configured to electrically connect the imaging device 30 to the cable 324, and thereby the processor.

The cap 303 may be configured to replace the rigid cap 220 of the meter 200, thereby facilitating a retrofit thereof. Accordingly, it may be provided with a coupling mechanism, such as a shaft 322 configured to hingedly articulate it to the meter 200, for example via apertures provided thereon for hingedly securing the rigid cap 220 thereto.

The power source 316 may be any suitable source of electric power. It may comprise batteries, which may be rechargeable. Optionally, a photovoltaic solar cell 318 may be provided to provide electrical energy to recharge the battery and/or power the components of the system 300.

The communications element 314 is configured for facilitating communication between the system 300 and an outside network, such as a cellular network. As such, it may comprise all necessary elements thereof, including, but not limited to, a wireless modem and/or network card and an antenna. The system 300 is configured to transmit and receive information via the communications element 314.

During operation of the system 300, the visual display 214 is imaged by the imaging device. The digital image acquired thereby is sent to the processor for recognition. The processor is preloaded with software configured to recognize the metered value as represented thereby. The processor may be configured to detect the type of indicator 222 present, and recognize the metered value displayed accordingly. The processor then transmits the recognized value via the communications element 314.

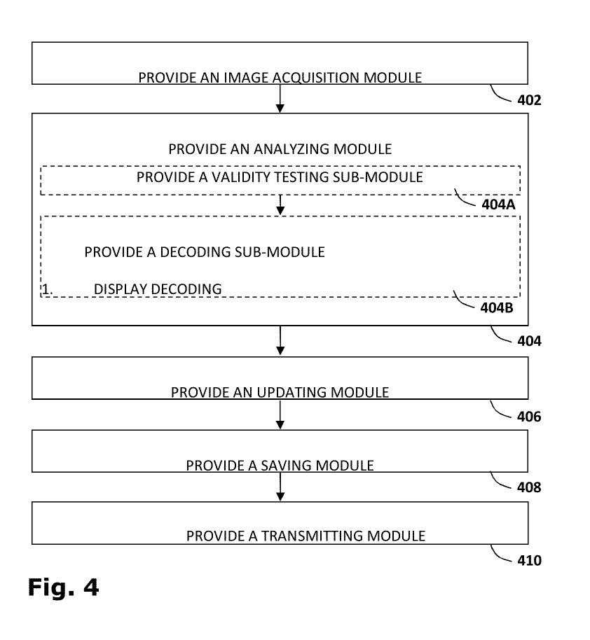

Reference is now made to flowchart of FIG. 4, representing a method for managing remote monitoring of a mechanical meter. The method includes the steps: providing an image acquisition module 402 to obtain the display readings; providing an analyzing module 404 to perform analysis of the acquired image, comprising of providing a validity testing sub-module 404a and a decoding sub-module 404b of the acquired image; providing an updating module 406; providing a saving module 408; and providing a transmitting module 410, to transmit the acquired display image and related information data to a remote machine.

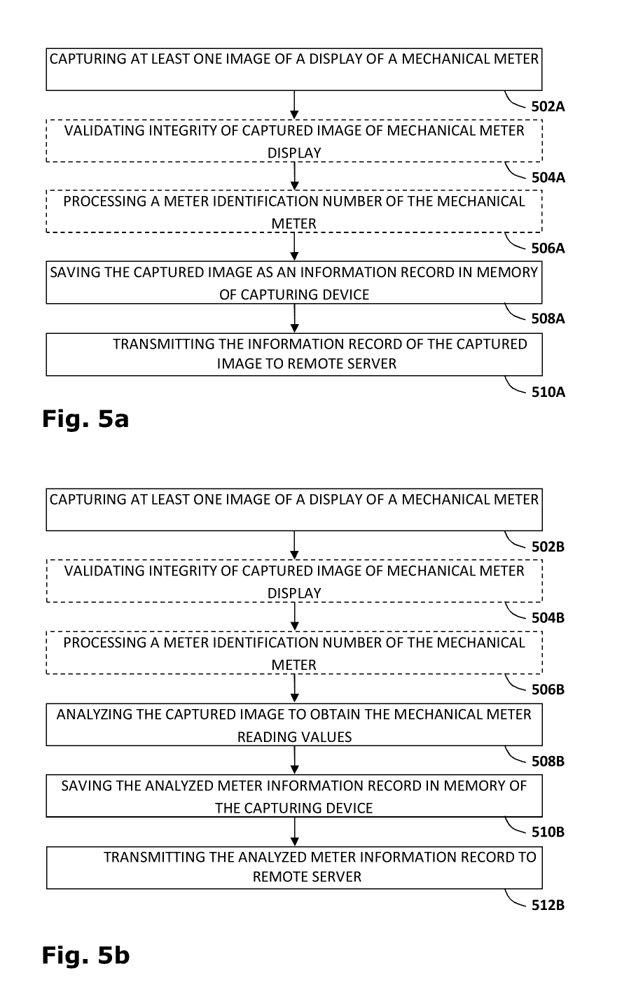

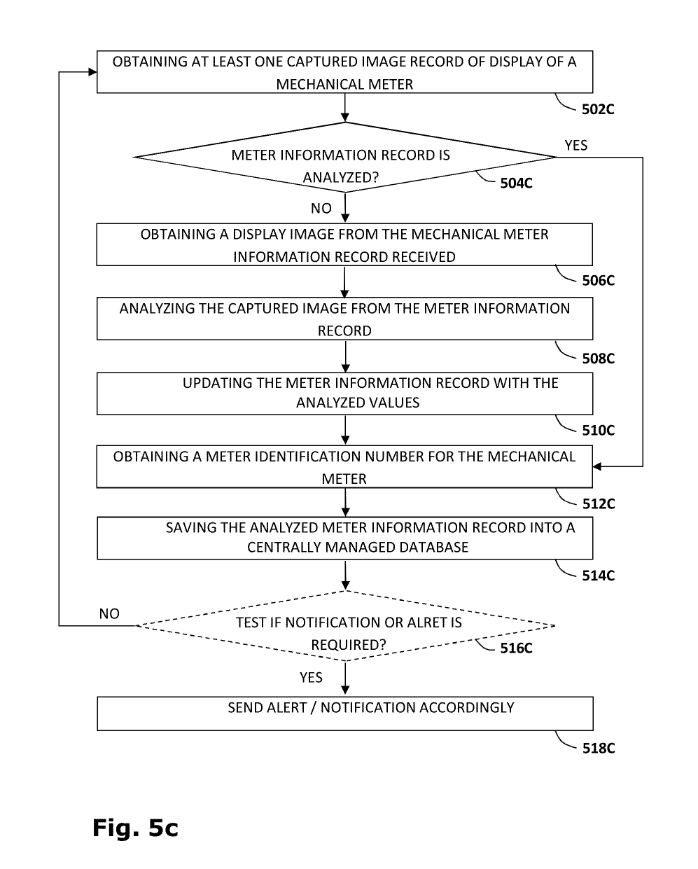

Reference is now made to the flow charts of FIGS. 5A through 5C, schematically representing selected actions of methods for handling a mechanical meter remote reading functionality through image acquisition, analyzing and transmitting of a reading display image record, combined with receiving functionality of transmitted data on a remote machine, such as management server, for further analysis and storage.

The methods of FIGS. 5A and 5B may be implemented by a data processing device installed on a retrofittable system of a mechanical meter, interacting with a remote machine server (not shown) where the method of FIG. 5C may be implemented.

It is noted that a display image reading record may be transmitted to a remote management server, for example, ‘as is’, without analyzing the acquired image, such as the implementation of the method of FIG. 5A, or may be analyzed and decoded to transmit the actual reading values such as the implementation of the method of FIG. 5B.

FIG. 5A provides a possible method of image acquisition of a mechanical meter display by a retrofittable system of current disclosure at the device itself, with actual readings of the mechanical meter display analyzed remotely, on a management server machine, for example. The acquired image may be stored into a ‘meter information record’ in memory of the capturing device associated with the mechanical meter and then transmitting the acquired data to a remote management server, for example. Optionally, the ‘meter information record’ may further be updated, before transmissions, with an acquisition timestamp and a mechanical meter identification number.

The method may include acquisition of at least one image of a mechanical meter reading display—step 502a. Optionally, the method may perform data integrity validation check of the acquired image—step 504a. Optionally, the method may further include identifying the mechanical meter identification number which may be decoded from the acquired image—step 506a, depending on supported functionality of the data processor. Thereafter, the acquired image may be saved into a ‘meter information record’ in memory of the image acquisition device—step 508a and transmitted to the remote machine over a cellular communication network for complete image analysis and decoding of the meter reading values—step 510a and further storage.

It is noted that the image acquisition device may be of different types or categories, such as laser-based detectors, charge-coupled device (CCD) camera systems, flatbed scanners and the like. FIG. 5B provides a another possible method of image acquisition of mechanical meter display by a retrofittable system of current disclosure at the device itself, but with actual readings of the mechanical meter decoded locally, by a data processing device installed on the retrofittable system. The acquired image and its decoded values may be stored into a ‘meter information record’ in memory of the image acquisition device associated with the mechanical meter, and then transmitting the information data record to a remote management server. Optionally, the ‘meter information record’ may further be updated, before transmissions, with a capture timestamp and a mechanical meter identification number.

The method may include acquiring at least one image of a mechanical meter reading display—step 502b. Optionally, the method may perform data integrity validation check of the acquired image—step 504b. Optionally, the method may further include identifying the mechanical meter identification number which may be analyzed from the acquired image—step 506b, depending on supported functionality of the data processor. The acquired image may be analyzed to determine the mechanical meter reading values—step 508b, and saved into a ‘meter information record’ in memory of the image acquisition device—step 510b. Thereafter, transmitting over a cellular communication network, the ‘meter information record’ to a remote machine—step 512b, for further storage, with possible accessibility to external user defined applications.

It is noted that an initial learning process may be applied by imaging at a high rate, those sections of the image with the highest rates of change, for example the right-hand side digits of a rotating dial or the like. Such a process may be of particular utility where the identification of the mechanical meter display is limited to ten orderly repeatable patterns (digits of 0 to 9). Following an initial learning phase, subsequent imaging may continue at a lower rate of image capture or lower resolution thereby reducing energy consumption.

Accordingly an identification process may be applied for reading measured values using a minimal resolution capturing element such as using an array of light sensors incorporated into a transparent sticker attached to the mechanical meter display. Such configuration may allow light intensity returning from the reading digits to be measured directly which may be interpreted as mechanical meter readings.

FIG. 5C provides a possible method of receiving readings data of a mechanical meter display, encapsulated in a meter information record, for example, and transmitted by the retrofittable system of the current disclosure. The received meter information record may include an acquired display image of a mechanical meter display only or analyzed readings of the mechanical meter only, depending on applicable functionality of the processing unit of the retrofittable system.

Optionally, the meter information record may include the acquired display image and the analyzed readings, if this functionality is supported by the processing unit.

The method of FIG. 5C may provide functionality, on a remote machine, of analyzing an incoming an external mechanical meter information record, by analyzing its display image to get its reading value at a specific time, and storing the related information for further usage.

The method may include obtaining at least one captured image of a mechanical meter reading display in a form of ‘meter information record’, for example—step 502c, then testing if the received record contains decoded image information—step 504c. If received record is not analyzed, the next step is to obtain the display image from the encapsulating meter information record—step 506c, analyzing the display image—step 508c and updating the associated record fields of meter information record with the decoded values—step 510c. Thereafter, the meter identification number of the mechanical meter may be obtained—step 512c used as record key, for example, for database storage of the meter information record.

Optionally, if the received record did contain an analyzed image display, steps 506c through 512c may be omitted.

Subsequently, the mechanical meter identification number may be obtained from the meter information record, to enable saving of the received updated record to a centrally managed database—step 514c. Optionally, the receiving method may be configured to provide an indication of a potential problem, based on analysis and comparison to previous meter readings—step 516c and trigger a notification or alert accordingly—step 518c.

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A system for reading a meter, the meter comprising a visual display behind by a transparent cover, said visual display comprising one or more indicators each representing a sub-value and together representing a metered value measured by the meter, the system comprising:
an imaging unit comprising an imaging device and an adhesive configured to facilitate mounting of the imaging unit over said cover of the meter such that said imaging device faces said visual display; and
a processor configured to recognize values represented by said indicators are imaged and calculate, based thereon, said metered value.

2. The system according to claim 1, wherein said imaging unit comprises an adhesive sheet comprising said imaging device.

3. The system according to claim 2, wherein said sheet comprises conductive lines configured to electrically connect said imaging device to the processor printed thereon.

4. The system according to claim 2, wherein said imaging unit further comprises a light source.

5. The system according to claim 4, wherein said light source comprises a light emitting diode.

6. The system according to claim 1, further comprising a communications element configured for wirelessly communicating the calculated values with a remote system.

7. The system according to claim 6, wherein said communications element is configured for communicating over a cellular network.

8. The system according to claim 1, further comprising a cap configured to be retrofitted to said meter, said cap houses functional elements of said system therewithin.

9. The system according to claim 8, wherein said functional elements includes the processor.

10. The system according to claim 8, wherein said cap is configured to be hingedly articulated to said meter.

11. The system according to claim 8, wherein said cap comprises a spring configured to bias said cap to a closed position on the meter.

12. The system according to claim 1, further comprising a power source.

13. The system according claim 12, wherein said power source comprises one or more batteries.

14. The system according to claim 13, wherein said one or more batteries are rechargeable.

15. The system according to claim 14, wherein said power source further comprises a solar cell configured to provide power to recharge said one or more batteries.

16. The system according to claim 1, wherein said meter is a water meter.

17. The system according to claim 1, wherein each of at least a portion of said indicators represents a different decimal position of a metered volume of water.

18. The system according to claim 17, wherein said portion of indicators comprises dials.

19. The system according to claim 17, wherein said portion of indicators comprises mechanical counters.

20. The system according to claim 17, wherein said portion comprises a digital display.
